(19) United States
(12) Patent Application Publication
(10) Pub. No.: US 2009/0301529 A1
(43) Pub. Date: Dec. 10, 2009

(54) Arrangement for the treatment of cellulose pulp in a washing apparatus arranged with seal removing means

(75) Inventors: Jörgen T. Lundberg, Sundsvall (SE); Rickard Andersson, Matfors (SE); Johan Bylander, Sundsvall (SE); Magnus Henriksson, Sundsvall (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: METSO PAPER INC., HELSINKI (FI)

(21) Appl. No.: 11/921,293

(22) PCT Filed: May 18, 2006
(86) PCT No.: PCT/SE2006/050136

§ 371 Date: Mar. 4, 2009

(30) Foreign Application Priority Data
Jun. 3, 2005 (SE) 0501288-5

(51) Int. Cl. B08B 13/00; F16J 15/02

(52) U.S. Cl. 134/115 R; 277/637

(57) ABSTRACT

A washer for washing and dewatering cellulose pulp is disclosed, comprising a rotary drum with a plurality of external compartments, which compartments are defined by axial compartment walls distributed along the circumference of the drum, a stationary cylindrical casing enclosing the drum, whereby a ring-shaped space is defined between the casing and the drum, and which by means of longitudinal seals in the axial direction of the drum is divided into a forming zone for forming the pulp, at least one washing zone for washing the pulp, and a discharge zone for feeding out the washed pulp where the casing is provided with longitudinal through openings in the axial direction for each longitudinal seal, in which the longitudinal seals are placed so that the seal can be removed from the washer in a direction outwardly from the drum center.

### FIELD OF THE INVENTION

The present invention relates to a washing arrangement of the type comprising a compartmented drum for washing and dewatering cellulose pulp. The present invention further includes a seal to be used in such a washing arrangement.

### BACKGROUND OF THE INVENTION

All fiber lines include some type of washing arrangement in order to separate the digestion liquor from the pulp. Later on in the process there is provided a washing arrangement to separate bleaching liquors after bleaching stages. There exist several different types of such washers operating according to different principles.

One type of washer is the drum washer where the pulp is dewatered on a rotary filter drum after the addition of washing liquid, which displaces the liquor remaining in the pulp web after preceding processing stages, for example a digestion stage or a bleaching stage. The static pressure causes the displaced liquor to pass through a perforated metal sheet mounted on the rotary drum. A further development of the original drum washer is the pressurized displacement washer where the filtrate at over pressure is caused to pass through the metal sheet. The increased pressure difference effects an improved dewatering of the pulp. In the pressurized displacement washer the increased difference in pressure can cause the pulp web to deposit itself harder on the metal sheet of the drum, and at times must be removed with some kind of auxiliary means. The pulp web, for example, then can be loosened by means of liquid or air.

According to a known design of pressurized displacement washers, the drum is provided with compartments, in which the pulp places itself in the form of rectangles, which are oval in the axial direction of the drum against the metal sheet. The compartmentalization of the drum ensures that the pulp cake does not break up and start moving, but instead maintains the form brought about at the deposition of the pulp. The compartments consist of bars placed axially along the entire axle of the drum, which bars are the walls of the compartments. The perforated metal sheet, on which the pulp deposits, is located spaced from the drum, so that filtrate channels are formed in the space between the drum and the sheet. Along the circumference of the drum there are thus at least as many filtrate compartments as pulp compartments. In a drum washer a plurality of different washing stages can be carried out, with separate addition of washing liquid to the different stages, and also recycling of filtrate from one stage as washing liquid to another stage.

In order to maintain maximum washing effectiveness, it is desirable to ensure that washing liquid intended for a specific washing stage is not moved to a later washing stage. washing liquid intended for a washing stage later in the process is cleaner than the washing liquid used in a preceding washing stage. A difference in pressure between the stages causes added washing liquid to tend to move to the lower pressure. In order to be able to separate different washing stages as well as forming stages and discharging stages, the respective zones are sealed by axial seals, which are placed between the compartment walls of the rotary drum and the surrounding casing. The filtrates from the respective stages are separated by seals in a peripheral end valve located at one or both of the end walls of the drum.

Fibers and other undesirable material arising between the compartment walls on the drum and the longitudinal seal cause the seal to become worn, and requires its replacement at regular intervals. In previously known designs the drum had to be lifted from the machine to make it possible to exchange at least the seals, which are located at the lower portion of the drum, below an imaginary center line. After the removal of the drum the seals can be taken away. The seals are removed in a direction from the casing inwardly towards the center of the drum. For the seals located on the upper portion of the drum, i.e. above the center line, at least the pressure-bearing casing enclosing the drum must be removed. This also implies that pipe connections and the like must be removed.

A design requiring removal of the entire drum for seal replacement implies long and relatively complicated interruptions for maintenance purposes. The possibilities are also small to change the design of the seal. Even in those cases where only the seals are to be exchanged, which are located on the washer's upper portion, a long and complicated operational break is required, because the pressure-bearing casing about the drum must be removed, at least its upper portion. As already mentioned, this also requires more work, because pipe connections, end seals, etc., have to be removed.

Furthermore, the seal must be made of a very durable material in order to avoid the need for frequent seal exchanges. Such a seal is inflexible and expensive, and the choice of material is determined to a great extent by the requirement for strength, to the disadvantage of flexibility of the sealing capacity.

One of the objects of the present invention is to solve the afore-said problems.

### SUMMARY OF THE INVENTION

In accordance with the present invention, this and other objects have now been realized by the discovery of a washer for washing and dewatering cellulosic pulp material comprising a rotary drum including a plurality of axial compartment walls extending along the rotary drum so as to create a plurality of external axial compartments for washing the cellulosic pulp material, a stationary cylindrical casing enclosing the rotary drum, thereby defining a ring-shaped space between the rotary drum and the stationary cylindrical casing, a plurality of longitudinal seals axially disposed along the rotary drum thereby dividing the ring-shaped space into a forming zone for forming the cellulosic pulp material, a washing zone for washing the cellulosic pulp material, and a discharge zone for discharging the washed cellulosic pulp material, a plurality of frames associated with the stationary cylindrical casing defining a plurality of axial passages along the rotary drum, each of the plurality of axial passages associated with one of the plurality of longitudinal seals, the plurality of longitudinal seals being removable from the rotary drum in a direction outwardly from the center of the rotary drum. In a preferred embodiment, the plurality of longitudinal seals are removable from the rotary drum radially outwardly from the center of the rotary drum.

In accordance with one embodiment of the washer of the present invention, the plurality of frames include frame walls encompassing each of the plurality of longitudinal seals. Preferably, the washer includes at least one positioning cylinder attached to one of the plurality of longitudinal seals for adjusting the radial position of the one of the plurality of longitudinal seals. In another embodiment, the plurality of frame includes dismountable frame covers.

In accordance with another embodiment of the washer of the present invention, the plurality of frames define at least two sections of the plurality of axial passages, and each of the at least two sections of the axial passages includes the plurality of longitudinal seals.

In accordance with another embodiment of the washer of the present invention, the plurality of longitudinal seals includes a bearing portion mounted on the at least one positioning cylinder and an exchangeable wear portion for sealing against the plurality of axial compartment walls. In a preferred embodiment, the washer includes fastening means for connecting the bearing portion of the exchangeable wear portion of the longitudinal seal, the joint between the fastening means and the bearing portion being detached in a direction to the frame walls. In another embodiment, the exchangeable wall portion comprises a polymer.

In accordance with the present invention, a seal is provided for use in a washer for washing and dewatering cellulosic pulp material comprising a rotary drum including a plurality of axial compartment walls extending along the rotary drum so as to create a plurality of external axial compartments for washing the cellulosic pulp material, a stationary cylindrical casing enclosing the rotary drum, thereby defining a ring-shaped space between the rotary drum and the stationary cylindrical casing, a plurality of longitudinal seals axially disposed along the rotary drum thereby dividing the rotary drum into a forming zone for forming the cellulosic pulp material, a washing zone for washing the cellulosic pulp material, and a discharge zone for discharging the washed cellulosic pulp material, a plurality of frames associated with the stationary cylindrical casing defining a plurality of axial passages along the rotary drum, each of the plurality of axial passages associated with one of the plurality of longitudinal seals, the plurality of longitudinal seals being removable from the rotary drum in a direction outwardly from the center of the rotary drum, and at least one positioning cylinder attached to one of the plurality of longitudinal seals for adjusting the radial position of the one of the plurality of longitudinal seals, the longitudinal seals comprising a bearing portion mounted on the at least one positioning cylinder and an exchangeable wear portion for sealing against the plurality of axial compartment walls. In a preferred embodiment, the longitudinal seals include fastening means for connecting the bearing portion and the exchangeable wear portion of the longitudinal seals, the joint between the fastening means and the bearing portion being removed in a direction to the edge of the frame. In a preferred embodiment, the exchangeable wear portion comprises a polymer.

In accordance with the present invention, by designing the washing arrangement with through openings in its overall casing for every longitudinal seal, the axial seals can be taken out in a direction outwardly, as seen from the drum center. The seals are preferably taken out in a direction radially outwardly. The drum can remain in its place and need not be removed, nor need the casing or pipe connections be removed in any portion of the washing arrangement.

The washing arrangement thus comprises a rotary drum with a plurality of outer compartments for the pulp to be washed, which compartments are defined by axial compartment walls distributed along the circumference of the drum, a stationary cylindrical casing enclosing the drum, whereby a ring-shaped space is defined between the casing and the drum, and where the ring-shaped space by means of longitudinal seals in the axial direction of the drum is divided into a forming zone for forming the pulp in the compartments of the drum, at least one washing zone for washing the pulp at an overpressure, and a discharge zone for feeding out the washed pulp.

The through openings in the casing can extend axially along the entire drum. According to one embodiment of the present invention, however, the opening is divided into two longitudinal sections, with one seal per section. The division into sections can be desirable, for example, in cases when the washer is provided with overall reinforcing ribs in order to ensure that detrimental deformation of the casing does not occur. These ribs extend about the entire circumference of the casing, across the longitudinal openings in the casing, and divide them into sections. The longitudinal openings in the casing can also be divided into more than two sections. For example, in the case when the washing arrangement is provided with a plurality of overall ribs, more than two sections are obtained. Preferably, a separate seal is provided in each of those sections. Due to having a seal in each such section, it is possible to dismantle the seal in a direction outwardly, counted from the center of the drum.

In every seal at least one positioning cylinder is located. Preferably, at least two positioning cylinders are provided at the seal. The positioning cylinders are preferably arranged symmetrically on the seal. By means of the positioning cylinders the abutment of the seal to the compartment walls of the drum is controlled. The seals are thus radially adjustable.

The opening in the casing can be provided with a frame bordering the opening. The frame walls consist of axial bars extending along the entire length of the opening in the axial direction of the casing and in height direction, i.e. radially, a distance above/outside the casing. Inside the casing the frame walls have an extension so that the walls are located at a small distance from the compartment walls of the outer compartments of the drum. The frame is preferably provided with a dismantable cover, which seals against the frame walls. Through the cover extends at least one positioning cylinder, which is mounted in the seal to adjust the same with respect to its radial position. By removing the dismantable cover the opening containing the seal is exposed, and it is thus possible to remove the seal in a direction outwardly, counted from the center of the drum. In one embodiment of the present invention, the entire package is removed, including the cover, positioning cylinder and the seal, in a direction outwardly, as seen from the center of the drum. The seal can then be dismantled from the positioning cylinder and exchanged with a new seal.

The seal has an extension in its width in the circumferential direction of the drum which is at least slightly greater than the distance between the inner sides of two axial bars constituting compartment walls. The extension of the seal in relation to the location of the compartment walls is such that at least one compartment wall is always within the extension of a seal.

By designing the seal to consist of two parts, one bearing part and one wear part, only the wear part situated closest to the compartment walls of the drum must be exchanged. The bearing part is mounted on the at least one positioning cylinder, and the wear part is attached to the bearing part. At seal exchange it is most often sufficient to exchange only the wear part. As the material of the wear part need not be the same as that of the bearing part of the seal, this part can be formed of a material which is optimized in view of its sealing function. The material for the wear part can thus be selected so that the wear on the drum can be minimized. The wear part consists, for example, of a polymer material, and it may also consist of a steel material. The wear part and the bearing part preferably consist of materials with different properties, but it is also possible to use the same type of material in both parts. The cost of exchange of a seal is still minimized, because only one part of the seal has to be exchanged.

### BRIEF DESCRIPTION OF THE DRAWINGS

The present invention is described in greater detail in the following detailed description, with reference to the Figures, in which:

FIG. 1 is a side, elevational, cross-sectional view of a portion of a compartmented drum washer in the area of a longitudinal seal in accordance with the present invention; and

FIG. 2 is a side, elevational, cross-sectional view of the compartmented drum washer shown in FIG. 1, with a seal according to the present invention.

### DETAILED DESCRIPTION

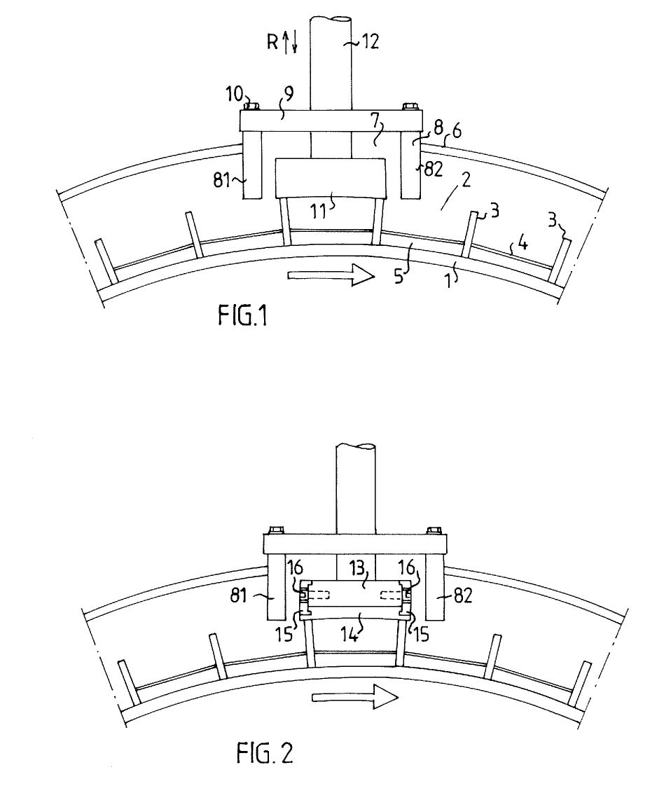

Referring to the Figures, in which like reference numerals refer to like elements thereof, FIG. 1 shows a cross-sectional view of a portion of a compartmented drum washer in the area of a longitudinal seal. On the rotary drum 1 a number of axial bars are located which separate the drum into a number of compartments 2, where the bars are compartment walls 3. The distance between the bars is constant along the entire circumference of the drum. In each compartment a number of support bars extend radially outward from the drum. On these support bars are resting perforated metal sheets 4, against which the pulp is dewatered. The filtrate passing through the sheet 4 enters a filtrate channel 5. At a distance outside the highest point of the compartment walls in the radial direction an external overall casing 6 is located. In the casing through elongated openings 7 are provided, the inner extension of which in the circumferential direction of the casing is slightly greater than the extension of the seal. The internal extension of the opening is defined by a frame structure 8, which consists of two frame walls, 81 and 82, which have an extension inside the casing so that the walls of the frame are almost on the same level as the compartment walls placed on the drum. The frame is provided with a cover 9, which is detachably connected with the frame walls, for example by bolts 10. A seal 11 is located in the opening 7, mounted in at least one positioning cylinder 12 for adjusting the radial position of the seal. The positioning cylinder extends through the cover 9. By means of the positioning cylinder 12 the position of the seal in relation to the compartment walls of the drum can be adjusted in a direction R radially according to the arrows shown in the Figure. When the seal is to be exchanged, the bolts 10 are loosened, so that seal, cover and positioning cylinder can be moved in a direction outward from the drum centre.

FIG. 2 shows a seal according to the present invention. The seal 11 has two parts, one bearing part 13 and one wear part 14, which can be removed from each other. The two parts are connected by at least one fastening means 15, which is mounted on the bearing part of the seal by a joint 16, which is located so that it is removed in a direction toward the frame walls, 81 and 82.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1-12. (canceled)

13. A washer for washing and dewatering cellulosic pulp material comprising a rotary drum including a plurality of axial compartment walls extending along said rotary drum so as to create a plurality of external axial compartments for washing said cellulosic pulp material, a stationary cylindrical casing enclosing said rotary drum, thereby defining a ring-shaped space between said rotary drum and said stationary cylindrical casing, a plurality of longitudinal seals axially disposed along said rotary drum thereby dividing said ring-shaped space into a forming zone for forming said cellulosic pulp material, a washing zone for washing said cellulosic pulp material, and a discharge zone for discharging said washed cellulosic pulp material, a plurality of frames associated with said stationary cylindrical casing defining a plurality of axial passages along said rotary drum, each of said plurality of axial passages associated with one of said plurality of longitudinal seals, said plurality of longitudinal seals being removable from said rotary drum in a direction outwardly from the center of said rotary drum.

14. The washer of claim 13 wherein said plurality of longitudinal seals are removable from said rotary drum radially outwardly from the center of said rotary drum.

15. The washer of claim 13 wherein said plurality of frames include frame walls encompassing each of said plurality of longitudinal seals.

16. The washer of claim 15 including at least one positioning cylinder attached to one of said plurality of longitudinal seals for adjusting the radial position of one of said plurality of longitudinal seals.

17. The washer of claim 15 wherein said plurality of frame includes dismountable frame covers.

18. The washer of claim 13 wherein said plurality of frames define at least two sections of said plurality of axial passages, and each of said at least two sections of said axial passages includes said plurality of longitudinal seals.

19. The washer of claim 16 wherein said plurality of longitudinal seals includes a bearing portion mounted on said at least one positioning cylinder and an exchangeable wear portion for sealing against said plurality of axial compartment walls.

20. The washer of claim 19 including fastening means for connecting said bearing portion and said exchangeable wear portion of said longitudinal seal, the joint between said fastening means and said bearing portion being detached in a direction to said frame walls.

21. The washer of claim 19 wherein said exchangeable wall portion comprises a polymer.

22. A seal for use in a washer for washing and dewatering cellulosic pulp material comprising a rotary drum including a plurality of axial compartment walls extending along said rotary drum so as to create a plurality of external axial compartments for washing said cellulosic pulp material, a stationary cylindrical casing enclosing said rotary drum, thereby defining a ring-shaped space between said rotary drum and said stationary cylindrical casing, a plurality of longitudinal seals axially disposed along said rotary drum thereby dividing said rotary drum into a forming zone for forming said cellulosic pulp material, a washing zone for washing said cellulosic pulp material, and a discharge zone for discharging said washed cellulosic pulp material, a plurality of frames associated with said stationary cylindrical casing defining a plurality of axial passages along said rotary drum, each of said plurality of axial passages associated with one of said plurality of longitudinal seals, said plurality of longitudinal seals being removable from said rotary drum in a direction outwardly from the center of said rotary drum, and at least one positioning cylinder attached to one of said plurality of longitudinal seals for adjusting the radial position of said one of said plurality of longitudinal seals, said longitudinal seals comprising a bearing portion mounted on said at least one positioning cylinder and an exchangeable wear portion for sealing against said plurality of axial compartment walls.

23. The seal of claim 22 wherein said longitudinal seals include fastening means for connecting said bearing portion and said exchangeable wear portion of said longitudinal seals, the joint between said fastening means and said bearing portion being removed in a direction to the edge of said frame.

24. The seal of claim 22 wherein said exchangeable wear portion comprises a polymer.
